(19) United States
(12) Patent Application Publication
(10) Pub. No.: US 2014/0087117 A1
(43) Pub. Date: Mar. 27, 2014

(54) POLYPHENYLENE SULFIDE COMPOSITIONS

(71) Applicant: E I DU PONT DE NEMOURS AND COMPANY, Wilmington, DE (US)

(72) Inventors: Robert John Duff, Newark, DE (US); Joachim C. Ritter, Wilmington, DE (US); Joel M. Pollino, Alpharetta, GA (US)

(73) Assignee: E I DU PONT DE NEMOURS AND COMPANY, Wilmington, DE (US)

(21) Appl. No.: 13/628,745

(22) Filed: Sep. 27, 2012

(51) Int. Cl. C08K 5/098; C08K 3/08; B32B 5/02; C09D 181/04; D04H 13/00; C08K 3/22; C08L 81/04

(52) U.S. Cl. 428/85; 524/399; 524/408; 524/439; 524/406; 442/327

(57) ABSTRACT

Provided are polyphenylene sulfide compositions having improved thermo-oxidative stability, methods for obtaining them, and articles comprising the compositions. The compositions comprise polyphenylene sulfide and a bismuth additive. The bismuth additive comprises a bismuth halide, an inorganic bismuth salt, a bismuth carboxylate, an oxide comprising bismuth and a transition metal, bismuth metal, or a mixture thereof. Optionally, the compositions further comprise at least one zinc(II) compound.

This application claims benefit of priority from U.S. Provisional Application No. 61/537,219, filed Sep. 21, 2011; U.S. Provisional Application No. 61/537,228, filed Sep. 21, 2011; and U.S. Provisional Application No. 61/537,240, filed Sep. 21, 2011; all of which are incorporated herein by reference in their entirety.

### FIELD

This invention relates to polyphenylene sulfide compositions and to methods of stabilizing them, for example against thermo-oxidative degradation.

### BACKGROUND

In applications such as the production of fibers, films, nonwovens, and molded parts from polyarylene sulfide resins, it is desirable that the molecular weight and viscosity of the polymer resin remain substantially unchanged during processing of the polymer. Various procedures have been utilized to stabilize polyarylene sulfide compositions such as polyphenylene sulfide (PPS) against changes in physical properties during polymer processing.

The use of certain bismuth compounds with polyarylene sulfide or polyphenylene sulfide has been disclosed. For example, published Patent Applications US 2005/0258404 and US 2010/0044599 disclose a polymer-bismuth composite comprising a plastic matrix having bismuth materials within it as “filler”. The bismuth compound may be bismuth oxide, or other bismuth compounds.

U.S. Pat. No. 7,771,646 discloses laser-markable molding compositions, molding produced therewith and method of marking the same, wherein the molding compositions comprise: (a) at least one semicrystalline thermoplastic; and (b) at least one particulate additive selected from the group consisting of (i) light-sensitive salt compounds, (ii) inorganic oxides having an average particle diameter of less than 250 nm, and combinations thereof; wherein the light-sensitive salt compounds comprise compounds having two or more captions, wherein at least one of the two or more captions is selected from the group consisting of Ti, Cr, Mn, Fe, Co, Ni, Cu, Zn, Y, Zr, Nb, Mo, Ag, Sn, Sb, La, Pr, Ta, W, and Ce; and wherein at least another of the two or more captions is selected from the group consisting of elements of periods 3-6 of main groups II and III, elements of periods 5-6 of main group IV, elements of periods 4-5 of transition groups III-VIII, and the lanthanoids.

Japanese Patent Application JP 2007227099 A discloses high dielectric polymer composites comprising polyphenylene sulfide, xBaO.yNd₂O₃.zTiO₂.wBi₂O₃ groups, and certain ceramic powders (STN abstract).

New polyarylene sulfide compositions exhibiting improved thermo-oxidative stability are continually sought, as are methods to provide improved thermo-oxidative stability to polyarylene sulfide compositions, especially polyphenylene sulfide compositions.

### SUMMARY

Described herein are compositions comprising polyphenylene sulfide and a bismuth additive. The compositions have improved thermo-oxidative stability in comparison to the polyphenylene sulfide without the bismuth additive when tested under the same conditions.

In one aspect, the composition comprises a bismuth halide, an inorganic bismuth salt, a bismuth carboxylate, an oxide comprising bismuth and a transition metal, bismuth metal, or a mixture thereof.

In another aspect, the composition further comprises at least one zinc(II) compound present in an amount in the range of from about 0.01 weight percent to about 10 weight percent, based on the weight of the polyphenylene sulfide.

In another aspect, articles comprising the bismuth-containing polyphenylene sulfide composition are described. The articles can be a fiber, a nonwoven fabric, a felt, a bag filter, a film, a coating, or a molded part.

In another aspect, a method for improving the thermo-oxidative stability of polyphenylene sulfide is described, the method comprising combining polyphenylene sulfide with a sufficient amount of a bismuth additive. In one embodiment, the method further comprises a step of adding at least one zinc(II) compound, wherein the zinc(II) compound has a loading in the range of about 0.01 weight percent to about 10 weight percent, based on the weight of the polyphenylene sulfide.

### DETAILED DESCRIPTION

The compositions, methods, and articles herein are described with reference to the following terms.

Where the indefinite article “a” or “an” is used with respect to a statement or description of the presence of a step in a process of this invention, it is to be understood, unless the statement or description explicitly provides to the contrary, that the use of such indefinite article does not limit the presence of the step in the process to one in number.

Where a range of numerical values is recited herein, unless otherwise stated, the range is intended to include the endpoints thereof, and all integers and fractions within the range. It is not intended that the scope of the invention be limited to the specific values recited when defining a range.

The following definitions are used herein and should be referred to for interpretation of the claims and the specification.

The term “PAS” means polyarylene sulfide.

The term “PPS” means polyphenylene sulfide.

The term “thermal stability”, as used herein, refers to the degree of change in the weight average molecular weight of a PAS polymer induced by elevated temperatures in the absence of oxygen. As the thermal stability of a given PAS polymer improves, the degree to which the polymer's weight average molecular weight changes over time decreases. Generally, in the absence of oxygen, changes in molecular weight are often considered to be largely due to chain scission, which typically decreases the molecular weight of a PAS polymer.

The term “thermo-oxidative stability”, as used herein, refers to the degree of change in the weight average molecular weight of a PAS polymer induced by elevated temperatures in the presence of oxygen. As the thermo-oxidative stability of a given PAS polymer improves, the degree to which the polymer's weight average molecular weight changes over time decreases. Generally, in the presence of oxygen, changes in molecular weight may be due to a combination of oxidation of the polymer and chain scission. As oxidation of the polymer typically results in cross-linking, which increases molecular weight, and chain scission typically decreases the molecular weight, changes in molecular weight of a polymer at elevated temperatures in the presence of oxygen may be challenging to interpret.

The term “° C.” means degrees Celsius.

The term “g” means gram(s).

The term “mg” means milligram(s).

The term “mol” means mole(s).

The term “s” means second(s).

The term “min” means minute(s).

The term “hr” means hour(s).

The term “rpm” means revolutions per minute.

The term “Pa” means pascals.

The term “psi” means pounds per square inch.

The term “mL” means milliliter(s).

The term “ft” means foot.

The term “weight percent” as used herein refers to the weight of a constituent of a composition relative to the entire weight of the composition unless otherwise indicated. Weight percent is abbreviated as “wt %”.

In the methods described herein, a polyphenylene sulfide is combined with a bismuth additive to obtain a polyphenylene sulfide composition having improved thermo-oxidative stability. The bismuth additive has a loading in the range of about 0.01 weight percent to about 10 weight percent. Optionally, at least one zinc(II) compound can also be added to provide further improvement in thermo-oxidative stability. The bismuth-containing polyphenylene sulfide compositions are useful for making articles such as fibers, nonwoven fabrics, and filter bags.

Polyarylene sulfides (PAS) include linear, branched or cross linked polymers that include arylene sulfide units. Polyarylene sulfide polymers and their synthesis are known in the art and such polymers are commercially available.

Exemplary polyarylene sulfides useful in the invention include polyarylene thioethers containing repeat units of the formula —[(Ar¹)ₙ—X]ₘ—[(Ar²)ᵢ—Y]ⱼ—(Ar³)ₖ—Z]ₗ—[(Ar⁴)ₒ—W]ₚ— wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes at least 30 mol %, particularly at least 50 mol % and more particularly at least 70 mol % arylene sulfide (—S—) units. Preferably the polyarylene sulfide polymer includes at least 85 mol % sulfide linkages attached directly to two aromatic rings. Advantageously the polyarylene sulfide polymer is polyphenylene sulfide (PPS), defined herein as containing the phenylene sulfide structure —(C₆H₄—S)ₙ— (wherein n is an integer of 1 or more) as a component thereof.

A polyarylene sulfide polymer having one type of arylene group as a main component can be preferably used. However, in view of processability and heat resistance, a copolymer containing two or more types of arylene groups can also be used. A PPS resin comprising, as a main constituent, a p-phenylene sulfide recurring unit is particularly preferred since it has excellent processability and is industrially easily obtained. In addition, a polyarylene ketone sulfide, polyarylene ketone ketone sulfide, polyarylene sulfide sulfone, and the like can also be used.

Specific examples of possible copolymers include a random or block copolymer having a p-phenylene sulfide recurring unit and an m-phenylene sulfide recurring unit, a random or block copolymer having a phenylene sulfide recurring unit and an arylene ketone sulfide recurring unit, a random or block copolymer having a phenylene sulfide recurring unit and an arylene ketone ketone sulfide recurring unit, and a random or block copolymer having a phenylene sulfide recurring unit and an arylene sulfone sulfide recurring unit.

The polyarylene sulfides may optionally include other components not adversely affecting the desired properties thereof. Exemplary materials that could be used as additional components would include, without limitation, antimicrobials, pigments, antioxidants, surfactants, waxes, flow promoters, particulates, and other materials added to enhance processability of the polymer. These and other additives can be used in conventional amounts.

As noted above, PPS is an example of a polyarylene sulfide. PPS is an engineering thermoplastic polymer that is widely used for film, fiber, injection molding, and composite applications due to its high chemical resistance, excellent mechanical properties, and good thermal properties. However, the thermal and oxidative stability of PPS is considerably reduced in the presence of air and at elevated temperature conditions. Under these conditions, severe degradation can occur, leading to the embrittlement of PPS material and severe loss of strength. Improved thermal and oxidative stability of PPS at elevated temperatures and in the presence of air are desired.

The polyphenylene sulfide may be used directly as obtained from the source or synthetic procedure, or it may be mechanically processed to reduce the size of the PPS solids and/or to increase the exposed surface area. Useful means of mechanical processing includes, but is not limited to, milling, crushing, grinding, shredding, chopping, and ultrasound. This mechanical processing may occur before or during combination with at least one bismuth additive.

The polyphenylene sulfide composition comprises at least one bismuth additive in an amount sufficient to impart improved thermo-oxidative stability to the polyphenylene sulfide. The bismuth additive may be chosen from commercially available materials or may be synthesized according to methods known in the art. Useful bismuth additives include, for example, bismuth halides such bismuth fluoride, bismuth chloride, bismuth bromide, bismuth iodide, or mixtures thereof; an inorganic bismuth salt such as bismuth hydroxide, bismuth subcarbonate, bismuth nitrate, bismuth oxychloride, bismuth oxynitrate, bismuth subnitrate, bismuth phosphate, or mixtures thereof; bismuth oxide; a bismuth carboxylate such as bismuth acetate, bismuth citrate, bismuth 2-ethylhexanoate, bismuth stearate, bismuth neodecanoate, bismuth subsalicylate, bismuth tris(2,2,6,6-tetramethyl-3,5-heptanedionate), or mixtures thereof; an oxide comprising bismuth and a transition metal, such as bismuth molybdate [Bi₂(MoO₄)₃], bismuth titanate (Bi₂O₃.2TiO₂), bismuth zirconate (2Bi₂O₃.3ZrO₂), or mixtures thereof; or bismuth metal. Mixtures of two or more types of bismuth compounds can also be used.

In one embodiment, the bismuth additive comprises bismuth(III). In one embodiment, the bismuth additive comprises a bismuth halide, an inorganic bismuth salt, a bismuth carboxylate, an oxide comprising bismuth and a transition metal, bismuth metal, or a mixture thereof. In one embodiment, the bismuth additive comprises bismuth metal. In one embodiment, the bismuth additive comprises a bismuth carboxylate, wherein the carboxylate is an acetate, a citrate, an ethylhexanoate, a stearate, a neodecanoate, a salicylate, or a mixture thereof. In one embodiment, the bismuth carboxylate comprises bismuth 2-ethylhexanoate. In one embodiment, the bismuth additive comprises an oxide comprising bismuth and a transition metal, wherein the transition metal is Ti, Mo, Zr, or is any mixture thereof.

The bismuth additive has a loading in the range from about 0.01 weight percent to about 10 weight percent, for example from about 0.05 weight percent to about 10 weight percent, or from about 0.10 weight percent to about 10 weight percent, or from about 0.5 weight percent to about 10 weight percent, or from about 1 weight percent to about 10 weight percent, based on the weight of the polyphenylene sulfide. Other useful ranges for the loading of the bismuth additive in the polyphenylene sulfide include from about 0.01 weight percent to about 9 weight percent, for example from about 0.05 weight percent to about 9 weight percent, or from about 0.10 weight percent to about 9 weight percent, or from about 0.5 weight percent to about 9 weight percent, or from about 1 weight percent to about 9 weight percent, from about 0.01 weight percent to about 5 weight percent, for example of about 0.05 weight percent to about 5 weight percent, or from about 0.10 weight percent to about 5 weight percent, or from about 0.5 weight percent to about 5 weight percent, or from about 1 weight percent to about 5 weight percent, based on the weight of the polyphenylene sulfide. Additional useful ranges for the loading of the bismuth additive include from about 0.01 weight percent to about 3 weight percent, for example of about 0.05 weight percent to about 3 weight percent, or from about 0.10 weight percent to about 3 weight percent, or from about 0.5 weight percent to about 3 weight percent, or from about 1 weight percent to about 3 weight percent, based on the weight of the polyphenylene sulfide.

Typically, the concentration of the bismuth additive can be higher in a master batch composition, for example from about 5 weight percent to about 10 weight percent, or higher.

In one embodiment, the polyphenylene sulfide composition further comprises at least one zinc(II) compound. The zinc(II) compound may be an organic compound, for example zinc stearate, or an inorganic compound such as zinc sulfate or zinc oxide, as long as the organic or inorganic counter ions do not adversely affect the desired properties of the polyphenylene sulfide composition. The zinc(II) compound may be obtained commercially, generated in situ, or synthesized according to methods known in the art. In one embodiment the zinc(II) compound comprises a zinc carboxylate. In one embodiment, the zinc carboxylate comprises zinc stearate.

In one embodiment, the zinc(II) compound comprises a zinc(II) carboxylate selected from the group consisting of Zn(O₂CR^{a})₂, or Zn(O₂CR^{a})(O₂CR^{b}), or mixtures thereof, where the radicals R^{a} and R^{b} are independently hydrocarbon moieties or substituted hydrocarbon moieties. The carboxylate moieties O₂CR^{a} and O₂CR^{b} may independently represent either linear or branched alkyl carboxylate anions with the proviso that if R^{a} and R^{b} are both linear, then either one of them or both of them independently contains nine or less carbon atoms. In one embodiment, the branched zinc(II) carboxylate comprises zinc di-(2-ethyl hexanoate), where R^{a}=R^{b}=—CH₂(C₂H₅)(CH₂)₃CH₃.

The zinc(II) compound may be present in the polyphenylene sulfide at a concentration of about 10 weight percent or less, based on the weight of the polyphenylene sulfide. For example, the zinc(II) compound may be present at a concentration of about 0.01 weight percent to about 5 weight percent, or for example from about 0.05 weight percent to about 5 weight percent, or from about 0.10 weight percent to about 5 weight percent, or from about 0.5 weight percent to about 5 weight percent, or from about 1 weight percent to about 5 weight percent, or from about 0.05 weight percent to about 2 weight percent, or from about 0.10 weight percent to about 2 weight percent, or from about 0.25 weight percent to about 2 weight percent, or from about 0.5 weight percent to about 2 weight percent. Typically, the concentration of the zinc(II) compound can be higher in a master batch composition, for example from about 5 weight percent to about 10 weight percent, or higher.

The bismuth additive and the optional zinc(II) compound may be added to the solid or molten polyphenylene sulfide as a solid, as a slurry, or as a solution. The zinc(II) compound may be added together with the bismuth additive or separately. In one embodiment, the polyphenylene sulfide is a melt, a solution, a solid, or a mixture thereof.

The combining of the polyphenylene sulfide with a bismuth additive and optionally with a zinc(II) compound is performed in any suitable vessel, such as a batch reactor or a continuous reactor. The suitable vessel may be equipped with a means, such as impellers, for agitating the contents. Reactor design is discussed in Lin, K.-H., and Van Ness, N. C. (in Perry, R. H. and Chilton, C. H. (eds), Chemical Engineer's Handbook, 5^{th} Edition (1973) Chapter 4, McGraw-Hill, NY). The combining step may be carried out as a batch process, or as a continuous process. In one embodiment, combining the polyphenylene sulfide with a bismuth additive may be performed in the same vessel as the combining with a zinc(II) compound.

The polyphenylene sulfide compositions disclosed herein are useful in various applications which require superior thermal resistance, chemical resistance, and electrical insulating properties. Articles comprising a polyphenylene sulfide composition as disclosed herein above include a fiber, a felt comprising a nonwoven web of fibers, a bag filter, a nonwoven fabric, a film, a coating, and a molded part. A bag filter typically has a tubular section, one closed end, and one open end, and a felt comprising a nonwoven web of fibers forms at least the tubular section of the filter bag. Such a fiber, felt, nonwoven fabric, or bag filter may be useful, for example, in filtration media employed at elevated temperatures, as in filtration of exhaust gas from incinerators or coal fired boilers with bag filters. Coatings comprising the novel polyphenylene sulfide compositions may be used on wires or cables, particularly those in high temperature, oxygen-containing environments.

In another embodiment of the invention, a method to improve the thermo-oxidative stability of polyphenylene sulfide is provided. The method comprises combining polyphenylene sulfide with a sufficient amount of at least one bismuth additive as disclosed herein. A sufficient amount is such that no significant increase in molecular weight is observed while heating the polyphenylene sulfide in air. The bismuth additive, optionally in combination with a zinc(II) compound as disclosed herein above, provides improved thermo-oxidative stability to the polyphenylene sulfide composition, meaning that at elevated temperatures in the presence of oxygen, changes over time in the weight average molecular weight of the polyphenylene sulfide polymer are decreased, relative to changes in the weight average molecular weight of polyphenylene sulfide polymer without the bismuth additive when tested under the same conditions. Improved thermo-oxidative stability is particularly desired, for example, for articles comprising PPS in the solid state which are used under conditions where exposure to oxygen at elevated temperatures may occur for an extended period of time. An example of such an article is a nonwoven fabric composed of a PPS fiber and used as a bag filter to collect dust emitted from incinerators, coal fired boilers, and metal melting furnaces.

### EXAMPLES

The present invention is further defined in the following examples. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

### Materials

The following materials were used in the examples. All commercial materials were used as received unless otherwise indicated. Fortron® 309 polyphenylene sulfide was obtained from Ticona Coporation of Florence, Ky. Fascat 2003 Tin (II) ethylhexanoate (85%) was obtained from Arkema Inc of Philadelphia, Pa. Zinc stearate (99%) was obtained from The Struktol Company of Stow, Ohio. Bismuth octoate, also referred to as bismuth 2-ethylhexanoate, (85%) and bismuth neodecanoate (90%) were obtained from The Shepherd Chemical Company of Norwood, Ohio. Bismuth oxide (99.9%), bismuth citrate (99.99%), bismuth metal (100 mesh, 99%), and bismuth molybdates, (99.9%) were obtained from Sigma-Aldrich of St. Louis, Mo. Bismuth acetate (99%) and bismuth titanate (98%) were obtained from Strem Chemicals Inc. of Newburyport, Ma.

Differential Scanning calorimetry Measurements

The thermo-oxidative stability of PPS compositions was assessed by measuring the melting point (Tm) as a function of exposure time in air. In one analysis method, solid PPS compositions were exposed to air at 250° C. over a period of time lasting from 5 to 100 days. In another analysis method, molten PPS compositions were exposed in air at 320° C. for 3 hours.

In the 250° C. Air Aging Method, samples (>20 g) of the compositions of the examples, controls, and comparative examples were weighed and separated in a 2 inch circular aluminum pan and placed into a 250° C. preheated mechanical convection oven with active circulation. After a period of time, usually every 7 days, an aliquot of each sample was removed and stored at room temperature to stop the aging process while the remaining portion of the sample continued to age in the oven. Each aged sample time point was analyzed by differential scanning calorimetry (DSC).

DSC was performed using a TA Instruments Q100 equipped with a TA Instruments Refrigerated Cooling System. Samples were prepared by accurately weighing 2-25 mg of PPS composition into a standard aluminum DSC pan. The temperature program was designed to erase the thermal history of the sample by first heating it above its melting point from 35° C. to 320° C. at 20° C./min and then allowing the sample to re-crystallize during cooling from 320° C. to 35° C. at 10° C./min. Reheating the sample from 35° C. to 320° C. at 10° C./min afforded the melting point of the sample, which was recorded and compared directly to melting point of corresponding examples, comparative examples and control PPS compositions. The entire temperature program was carried out under nitrogen purge at a flow rate of 50 mL/min. All melting points were quantified using TA's Universal Analysis Software via the software linear peak integration function.

This method is used to determine the number of days required by a sample to reach the melting point of 262° C. as determined by DSC aging (Tm). The time needed to reach this low melting point can be an indicator of how well physical properties, such as tensile strength and elongation, might be maintained under the test conditions. In Table 1, where a sample did not degrade at a temperature of 262° C. during the duration of the experiment, it is denoted as having a period to melting point of greater than (>) the time period measured (in days).

In the molten air exposure method samples were prepared by accurately weighing 8-12 mg of individual composition of examples and comparative examples inside a standard aluminum DSC pan without a lid. DSC was performed using a TA Instruments Q100 equipped with a TA Instruments Refrigerated Cooling System. The temperature program was designed to melt the polymer under nitrogen, expose the sample to air at 320° C. for 180 min, crystallize the air-exposed sample under nitrogen and then reheat the sample to identify changes in the melting character. Thus, each sample was heated from 35° C. to 320° C. at 20° C./min under nitrogen at a flow rate of 50 mL/min and held isothermally for 5 minutes, at which point the purge gas was changed from nitrogen to air at a flow rate of 50 mL/min while maintaining the temperature of 320° C. for 180 minutes. Subsequently, the purge gas was switched back from air to nitrogen at a flow rate of 50 mL/min and the sample was cooled from 320° C. to 35° C. at 10° C./min and then reheated from 35° C. to 320° C. at 10° C./min to measure the melting characteristic of the air-exposed material. The melt characteristic of the air-exposed material was quantified using TA's Universal Analysis software via the software's inflection of onset function. A lower temperature of the inflection point in the melt curve indicates a higher degree of oxidative decomposition.

Three master batch compositions of PPS containing different additives were prepared using the following procedures.

### Comparative Example A

### PPS Containing Zinc Stearate and Tin (II) Ethylhexanoate

A master batch PPS composition, referred to herein as Comparative Example A, containing 6.6 weight percent zinc stearate and 3.4 weight percent tin(II) 2-ethylhexanoate was produced using an extrusion process. Fortron® 309 PPS (90 parts) was melt compounded in a Coperion 18 mm intermeshing co-rotating twin-screw extruder with a side stuffer, through which was added zinc stearate (6.6 parts), and a liquid metering pump, through which was added tin (II) 2-ethylhexanoate (3.4 parts) down stream into the melted polymer. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was quenched in a 6 ft tap water trough prior to being pelletized by a Conair chopper to give a pellet count of 100-120 pellets per gram.

### Comparative Example B

### PPS Containing Zinc Stearate

A master batch PPS composition, referred to herein as Comparative Example B, containing 6.6 weight percent zinc stearate was produced using an extrusion process as described for Comparative Example A except that the liquid metering pump was not used. Fortron® 309 PPS (93.4 parts) was melt compounded in a Coperion 18 mm intermeshing co-rotating twin-screw extruder with a side stuffer adding zinc stearate (6.6 parts) down stream into the melted polymer.

### Example 1

### PPS Containing Bismuth(III) 2-Ethylhexanoate

A master batch PPS composition, referred to herein as Example 1, containing 10 weight percent bismuth 2-ethylhexanoate was produced using an extrusion process as described for Comparative Example A except that the side stuffer was not used. Fortron® 309 PPS (90 parts) was melt compounded in a Coperion 18 mm intermeshing co-rotating twin-screw extruder with a liquid metering pump adding bismuth 2-ethylhexanoate (10 parts) down stream into the melted polymer.

Examples 2 and 3 and Comparative Examples C, D, and E were prepared by melt compounding a portion of the master batch compositions with Fortron® 309 PPS using the following procedures.

### Comparative Example C

### PPS Containing 2.64 Wt % Zinc Stearate

A compounded PPS composition, referred to herein as Comparative Example C, containing 2.64 weight percent zinc stearate was produced using an extrusion process. Fortron® 309 PPS (6 parts) was melt compounded in a Coperion 18 mm intermeshing co-rotating twin-screw extruder with a gravimetric feeder adding master batch Comparative Example B (4 parts) at the feed throat prior to polymer melt. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was quenched in a 6 ft tap water trough prior to being pelletized by a Conair chopper to give a pellet count of 100-120 pellets per gram.

### Comparative Example D

### PPS Containing 2.64 Wt % Zinc Stearate and 1.36 Wt % Tin (II) Ethylhexanoate

A compounded PPS composition, referred to herein as Comparative Example D, containing 2.64 weight percent zinc stearate and 1.36 weight percent tin (II) ethylhexanoate was produced using an extrusion process as described for Comparative Example C except that Fortron® 309 PPS (6 parts) was melt compounded with master batch Comparative Example A (4 parts).

### Example 2

### PPS Containing 4 Wt % Bismuth 2-Ethylhexanoate

A compounded PPS composition, referred to herein as Example 2, containing 4% weight percent bismuth 2-ethylhexanoate was produced using an extrusion process as described for Comparative Example C except that Fortron® 309 PPS (6 parts) was melt with master batch Example 1 (4 parts).

### Example 3

### PPS Containing 2.64 Wt % Zinc Stearate and 4 Wt % Bismuth 2-Ethylhexanoate

A compounded PPS composition, referred to herein as Example 3, containing 2.64% zinc stearate and 4% weight percent bismuth 2-ethylhexanoate was produced using an extrusion process as described for Comparative Example C except that Fortron® 309 PPS (2 parts) was melt compounded in a Coperion 18 mm intermeshing co-rotating twin-screw extruder with gravimetric feeders adding master batch Comparative Example B (4 parts) and master batch Example 1 (4 parts) at the feed throat prior to polymer melt.

### Comparative Example E

### Extruded Fortron® 309 PPS (Control)

A control sample of extruded PPS was prepared as follows. A compounded PPS composition, referred to herein as Comparative Example E, containing no additive was produced using an extrusion process as described for Comparative Example C except that Fortron® 309 PPS (100 parts) was melt compounded in a Coperion 18 mm intermeshing co-rotating twin-screw extruder with no additives.

TABLE 1
Melting Point Data from 250° C. Air Aging Method

| | | Initial | Days of Aging |
|---|---|---|---|
| | | Melting | To Reach |
| PPS | | Point Prior | Melting Point |
| Sample | Loading (wt %) and Additive | to Aging | of 262° C. |
| Comp Ex C | 2.64% zinc stearate | 282.8 | 27 |
| Comp Ex D | 2.64% zinc stearate & 1.32% | 282.7 | 27 |
| | tin(II) ethylhexanoate | | |
| Ex 2 | 4% bismuth 2-ethylhexanoate | 283.9 | 31 |
| Ex 3 | 2.64% zinc stearate & 4% | 282.3 | >60 |
| | bismuth 2-ethylhexanoate | | |
| Comp Ex E | — | 282.6 | 13 |

The data in Table 1 shows that the addition of bismuth 2-ethylhexanoate (Example 2) increased the solid state thermo-oxidative stability of the PPS considerably. Example 2 took more than twice as long as Comparative Example E to reach the 262° C. melting point, and several days longer than Comparative Examples C and D. The thermo-oxidative stability of the PPS was further increased by the addition of a zinc compound (zinc stearate) in Example 3. Example 3 maintained a melting point above 262° C. during the 60 days it was tested by this method.

The PPS samples of Examples 4 through 13 and Comparative Examples F and G were prepared using the following dry blending procedure. Fortron® 309 PPS was added to a Waring blender with variable speed control. While the PPS powder was mixing in the blender, the indicated additive(s) was added in an amount sufficient to provide a PPS sample having the indicated additive loading, based on the total weight of PPS and additive(s) used. Blending continued for several minutes after addition of the additive(s) to ensure that a homogenous mixture was obtained. The PPS samples and their molten air exposure melt characteristic data are summarized in Table 2.

TABLE 2
PPS Samples Prepared by Dry Blending and Their Molten Air
Exposure Melt Characteristic Data

| | | Melt Inflection |
|---|---|---|
| Sample | Loading of Additive in PPS Product | Point (° C.) |
| Fortron ® 309 | No additive, no molten air exposure | 275.5 |
| PPS | | |
| Comp Ex F | No additive. Fortron ® 309 control | 246.0 |
| Comp Ex G | 1 wt % zinc stearate | 258.2 |
| Example 4 | 1 wt % bismuth 2-ethylhexanoate | 255.6 |
| Example 5 | 1.1 wt % bismuth neodecanoate | 256.6 |
| Example 6 | 1 wt % bismuth oxide | 254.6 |
| Example 7 | 1 wt % bismuth titanate | 251.6 |
| Example 8 | 1.1 wt % zinc stearate and 1.4 wt % | 262.8 |
| | bismuth 2-ethylhexanoate | |
| Example 9 | 0.63 wt % bismuth citrate | 257.1 |
| Example 10 | 0.38 wt % bismuth metal | 255.7 |
| Example 11 | 1.39 wt % bismuth molybdate | 258.0 |
| Example 12 | 0.70% bismuth acetate | 260.0 |
| Example 13 | 0.2 wt % bismuth subsalicylate | 259.7 |

The data for the Examples show that the inflection point of the melt character as found by DSC increases as less thermo-oxidative degradation occurs, meaning that the higher the melt inflection point after molten air exposure, the higher the efficacy of the stabilizer in the PPS. Without any additive, the PPS of Comparative Example F showed a melt inflection point of 246° C., a 29 degree drop from the 275.5° C. melt inflection point of the same PPS before exposure to air in the molten state. In contrast, all Examples of PPS containing a bismuth additive showed much smaller drops in the melt inflection point, indicating the thermo-oxidative stabilizing effect of the bismuth compounds. Examples 11, 12, and 13 showed the greatest thermo-oxidative stability for PPS containing only a bismuth additive, while Example 8, which contained both bismuth 2-ethylhexanoate and zinc stearate, demonstrated the greatest melting point retention, which was also better than the use of zinc stearate alone (Comparative Example G).

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

Although particular embodiments of the present invention have been described in the foregoing description, it will be understood by those skilled in the art that the invention is capable of numerous modifications, substitutions, and rearrangements without departing from the spirit of essential attributes of the invention. Reference should be made to the appended claims, rather than to the foregoing specification, as indicating the scope of the invention.

What is claimed is:

1. A composition comprising polyphenylene sulfide and a bismuth additive.

2. The composition of claim 1 comprising bismuth(III).

3. The composition of claim 1 comprising: a bismuth halide; an inorganic bismuth salt; a bismuth carboxylate; an oxide comprising bismuth and a transition metal; bismuth metal; or a mixture thereof.

4. The composition of claim 3 comprising bismuth metal.

5. The composition of claim 3 comprising a bismuth carboxylate, wherein the carboxylate is an acetate, a citrate, an ethylhexanoate, a stearate, a neodecanoate, a salicylate, or a mixture thereof.

6. The composition of claim 5 wherein the bismuth carboxylate comprises bismuth 2-ethylhexanoate.

7. The composition of claim 3 comprising an oxide comprising bismuth and a transition metal, wherein the transition metal is Ti, Mo, Zr, or is any mixture thereof.

8. The composition of claim 1 wherein the bismuth additive has a loading in the range of about 0.01 weight percent to about 10 weight percent, based on the weight of the polyphenylene sulfide.

9. The composition of claim 1 further comprising at least one zinc(II) compound present in an amount in the range of from about 0.01 weight percent to about 10 weight percent, based on the weight of the polyphenylene sulfide.

10. The composition of claim 9 wherein the zinc compound comprises a zinc carboxylate.

11. The composition of claim 10 wherein the zinc carboxylate comprises zinc stearate.

12. The composition of claim 1 having improved thermo-oxidative stability in comparison to that of the polyphenylene sulfide without the bismuth additive when tested under the same conditions.

13. An article comprising the composition of claim 1.

14. The article of claim 13, wherein the article is a fiber, a nonwoven fabric, a felt, a bag filter, a film, a coating, or a molded part.

15. The article of claim 13, wherein the composition further comprises at least one zinc(II) compound present in an amount in the range of from about 0.01 weight percent to about 10 weight percent, based on the weight of the polyphenylene sulfide.
